(19) United States
(12) Patent Application Publication
(10) Pub. No.: US 2016/0246397 A1
(43) Pub. Date: Aug. 25, 2016

(54) A TOUCH SCREEN WITH MUTUAL CAPACITANCE

(71) Applicant: SHENZHEN CHINA STAR OPTOELECTRONICS TECHNOLOGY CO. LTD., Shenzhen, Guangdong (CN)

(72) Inventors: Chengliang YE, Shenzhen, Guangdong (CN); Chun Kai CHANG, Shenzhen, Guangdong (CN); Jie QIU, Shenzhen, Guangdong (CN); Yung-Lun LIN, Shenzhen, Guangdong (CN)

(21) Appl. No.: 14/131,305

(22) PCT Filed: Nov. 20, 2013
(86) PCT No.: PCT/CN2013/087497

§ 371 Date: Jan. 7, 2014

(30) Foreign Application Priority Data
Sep. 27, 2013 (CN) 20131045276.7

(51) Int. Cl. G06F 3/044

(52) U.S. Cl. CPC G06F 3/044; G06F 2203/04111

(57) ABSTRACT

A touch screen with mutual capacitance comprises a touch substrate, a metal support, an insulating layer and at least two transparent conductive thin film layers. The metal support layer comprises a lateral support and a longitudinal support which the two supports are perpendicular to each other and not on the same plane; The insulating layer is sandwiched between the lateral support and the longitudinal support; The transparent conductive thin film layers comprises lateral and longitudinal transparent conductive thin film layer. A lateral electrode is formed by electrically connecting the lateral support with the lateral transparent conductive thin film layer, a longitudinal electrode is the same made. The RC loading will be reducing with the signal transmitting by the metal support layer, so that the lateral and longitudinal transparent conductive thin film layers can be made larger to suitable for the large-size touch screen with mutual capacitance.

### FIELD OF THE INVENTION

The invention relates to a touch screen, more particularly relates to a touch screen with mutual capacitance which can be adapted at the large-size screen.

### BACKGROUND OF THE INVENTION

With the technology development, the display screen on the computer, mobile phone, digital camera and MP3 and other electrical devices will be replayed by the touch screen.

The touch screens comprise resistance-type screen, electric capacity screen, infrared ray screen and surface acoustic wave screen. The principle of the electric capacity is made use of the current induction from someone body. When the conductor contacts on the touch screen, a coupling capacitance is formed between the conductor and the surface of the touch screen. For high-frequency current, the electric capacity is a direct conductor. The conductor can attract a little current from the contact point. The current is flowing from the electrode of the four corners on the touch screen. The current from the four electrodes is proportional to the distance from the conductor to the corners. The touch position will be found after the calculating on the ratio of the four current.

On the traditional touch screen with mutual capacitance, the transparent conductive thin film layer is used to be the electrode conducting layer. However, with limiting of the hardness of the thin film, the large-size touch screen with mutual capacitance is difficultly to be manufactured. When the touch screen is deformed on force, the interface will be separated to bring the electrode circuit break. As a result, the touch action will be lost efficacy and the touch induction component will be even damaged. Using the metal to be electrode conducting layer, the light transmittance will be decrease.

Therefore, it is necessary to provide a touch screen with mutual capacitance with touch sensitivity improving, support degree raising and light transmittance increasing.

### SUMMARY OF THE INVENTION

To overcome about shortages, the main purpose of the present invention is provided for a touch screen with mutual capacitance with touch sensitivity improving, resistance reducing and light transmittance increasing.

The present invention provides a touch screen with mutual capacitance which comprising:

a touch substrate;

a metal support layer mounted under the touch substrate, the metal support layer comprises a lateral support and a longitudinal support which the two supports are perpendicular to each other and not on the same plane;

an insulating layer sandwiched between the lateral support and the longitudinal support;

at least two transparent conductive thin film layers comprising a lateral transparent conductive thin film layer and a longitudinal transparent conductive thin film layer, a lateral electrode is made by the electrically connecting the lateral support with the lateral transparent conductive thin film layer, a longitudinal electrode is made by the electrically connecting the longitudinal support with the longitudinal transparent conductive thin film layer, the lateral transparent conductive thin film layer is covered along the lateral support, and the width of the lateral transparent conductive thin film layer is larger than the lateral support in the vertical direction. The transparent conductive thin film layers are made of tin indium oxide and the insulating layer is made of silicon nitride or silicon dioxide.

Preferably, the longitudinal transparent conductive thin film layer is covered along the longitudinal support, and the width of the longitudinal transparent conductive thin film layer is also larger than the longitudinal support to widen the contact area of the longitudinal electrode.

Preferably, the insulating layer has different mounting ways. One mounting way is that the insulating layer is entire covered on the lateral support and the touch substrate. A through hole is opening on the insulating layer of the lateral support, and the lateral transparent conductive thin film layer is connecting with the lateral support by the wire through the through hole. The longitudinal transparent conductive thin film layer is directly connecting with the longitudinal support. Another mounting way is that the insulating layer is sandwiched on the staggered positions between the lateral support and the longitudinal support, so as to ensure the two supports keeping insulate.

Preferably, there are four transparent conductive thin film layers around the staggered positions of the lateral support and the longitudinal support, the transparent conductive thin film layers comprises two lateral transparent conductive thin film layers and two longitudinal transparent conductive thin film layers. The four transparent conductive thin film layers are covered on the same plane.

Preferably, a plurality of touch areas are formed by the lateral supports and longitudinal supports vertically intersecting, the transparent conductive thin film layers on the touch areas are insulated to each other. With the touching on the several touch areas, the sensitivity of the touch screen is improved.

If the conductor not contacts on the touch substrate, the voltage between the mutual capacitance is V2=V1×C1/(C1+C3);

if the conductor contacts on the touch substrate, the voltage between the mutual capacitance is V2′=V1*C1/(C1+C2+C3);

the anti noise ratio is V2-V2′;

wherein V1 is input voltage of the touch screen, C1 is mutual capacitance between the lateral electrode and the longitudinal electrode, C2 is conductor capacitance between the conductor and the lateral electrode or the longitudinal electrode, C3 is parasitic capacitance between the lateral electrode or the longitudinal electrode and the touch substrate.

Compared to the prior art, the present touch screen with mutual capacitance comprises the metal support layer and the transparent conductive thin film layer combined together. Using the metal support layer to be the transmitting terminal and the receiving terminal of the electrode, the resistance value of the metal support will be reduced and thus RC loading also will be smaller. To solve the disadvantages of the metal support layer with light-proof and reflecting the external light, the transparent conductive thin film layer can be electroplated on the metal support layer to enlarge the touch area by the conduct and ensure the transmittance of the touch screen. The RC loading will be reducing with the signal transmitting by the metal support layer, so that the lateral transparent conductive thin film layer and the longitudinal transparent conductive thin film layer can be made even larger to suitable for the large-size touch screen with mutual capacitance.

### BRIEF DESCRIPTION OF THE DRAWINGS

FIG. 1 is a longitudinal side view of the touch screen with mutual capacitance;

FIG. 2 is a lateral side view of the touch screen with mutual capacitance in the first embodiment;

FIG. 3 is a lateral side view of the touch screen with mutual capacitance in the second embodiment;

FIG. 4 is a vertical view of the insulating layer of the touch screen with mutual capacitance in the first embodiment;

FIG. 5 is a vertical view of the insulating layer of the touch screen with mutual capacitance in the second embodiment;

FIG. 6 is a vertical view of the touch screen with mutual capacitance in the first embodiment;

FIG. 7 is a vertical view of the touch screen with mutual capacitance in the second embodiment;

FIG. 8 is a partial enlarged view of the touch screen with mutual capacitance in the first embodiment;

FIG. 9 is a partial enlarged view of the touch screen with mutual capacitance in the second embodiment; and

FIG. 10 is distribution view of the electric capacity of the touch screen with mutual capacitance.

### DETAILED DESCRIPTION OF THE PREFERRED EMBODIMENTS

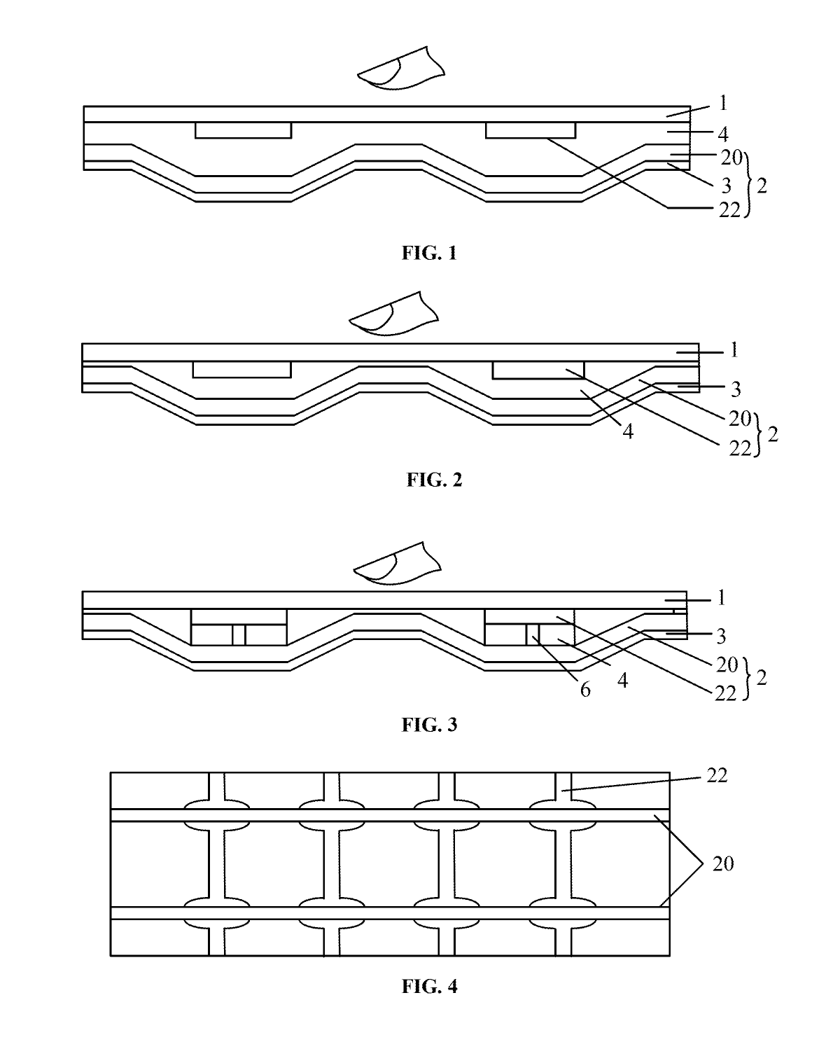

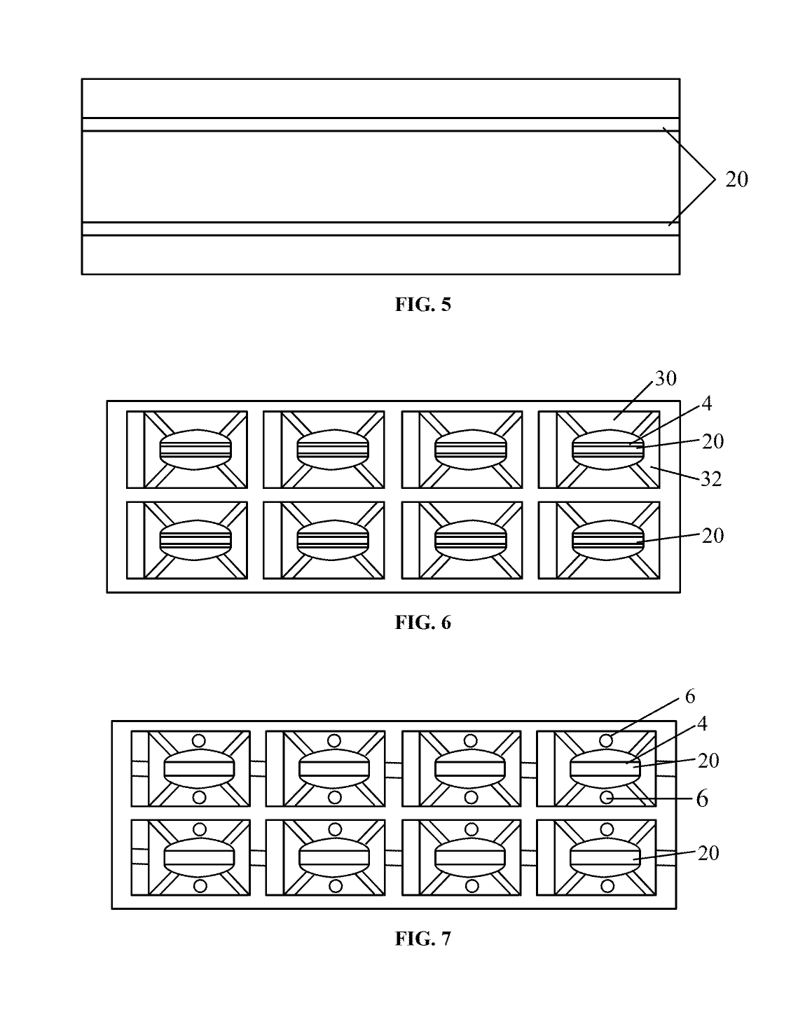

Refer to FIGS. 1-3 and FIG. 6, on the longitudinal side view and lateral side view of the touch screen, for improving the sensitivity and light transmittance of the touch screen, the present invention provides a new touch screen with mutual capacitance comprising a touch substrate 1, a metal support layer 2 and at least two transparent conductive thin film layers 3. The touch substrate 1 is covered upon the touch screen. The metal support layer 2 is mounted under the touch substrate 1 for supporting the touch substrate 1 and conducting current. The metal support layers 2 comprise lateral supports 20 and longitudinal supports 22 which the two supports are perpendicular to each other and not on the same plane. The lateral support 20 and the longitudinal support 22 are crisscross to form a meshy metal support structure. The transparent conductive thin film layers 3 comprises a lateral transparent conductive thin film layer 30 and a longitudinal transparent conductive thin film layer 32, which are covered on the metal support layer 2 by coating film or pasting to electrically connect with the metal support layer 2. A lateral electrode is made by the electrically connecting the lateral support 20 with the lateral transparent conductive thin film layer 30. A longitudinal electrode is made by the electrically connecting the longitudinal support 22 with the longitudinal transparent conductive thin film layer 32. The lateral electrode and the longitudinal electrode are combined to be a mutual capacitance. The transparent conductive thin film layers 3 are made of tin indium oxide (ITO). The insulating layer 4 is sandwiched between the lateral support 20 and the longitudinal support 22 for blocking them electrically connecting together. When the conductor closes to the touch substrate, the conductor capacitance is appeared which is formed between the conductor and the lateral electrode or the longitudinal electrode. When the conductor contacts on the touch substrate, the voltage between the two sides of the mutual capacitance will be change with the change of the conductor capacitance. The position of the conduct contacting will be found after calculating the change of the voltage.

The lateral transparent conductive thin film layer 30 is covered along the lateral support 20, and the width of the lateral transparent conductive thin film layer 30 is larger than the lateral support 20 in the vertical direction to enlarge the contact area of the lateral electrode. Similarly, the longitudinal transparent conductive thin film layer 32 is covered along the longitudinal support 22, and the width of the longitudinal transparent conductive thin film layer 32 is also larger than the longitudinal support 22 to enlarge the contact area of the longitudinal electrode. Therefore, the contact area of the whole lateral electrode and the longitudinal electrode is enlarged for more adapting the large-size touch screen.

Refer to FIGS. 4, 6 and 8, a plurality of metal support layers 2 comprise the lateral supports 20 and the longitudinal supports 22 vertically to each other. In the first embodiment, refer to FIG. 3, the two lateral supports are in parallel and the four longitudinal supports 22 also in parallel. The insulating layer 4 is sandwiched on the staggered positions which is between the lateral support 20 and the longitudinal support 22 for ensure the two supports keeping insulate. And then, the lateral supports 20 are electrically connecting to the lateral transparent conductive thin film layers 30. The longitudinal supports 22 are electrically connecting with the longitudinal transparent conductive thin film layers 32 around the insulating layer 4. The lateral support 20 and the longitudinal support 22 are insulating to each other. The lateral support 20 is symmetrically extended in the lateral direction. The centre point of the lateral support 20 is the pivot point of the longitudinal support 22 which symmetrically extended in the longitudinal direction. The lateral support 20 and the longitudinal support 22 are combined to be a square or oblong shape support. With the extending of the transparent conductive thin film layers, the conducting area of the touch screen is increasing to more suitable to the large-size touch screen.

In the second embodiment, refer to FIGS. 3, 7 and 9, the insulating layer 4 is sandwiched between the lateral support 20 and the longitudinal transparent conductive thin film layer 32. Moreover, the insulating layer 4 is entire covered on the lateral support 20 and the touch substrate 1. In the lateral direction, the lateral electrode is formed by the lateral support 20 electrically connecting with the lateral transparent conductive thin film layer 30 directly. In the longitudinal direction, the longitudinal support 22 is separated with the longitudinal transparent conductive thin film layer 32 by the insulating layer 4. A through hole 6 is opening on the insulating layer 4 of the longitudinal support 22. The longitudinal transparent conductive thin film layer 32 is connecting with the longitudinal support 22 by the wire through the through hole 6. The lateral transparent conductive thin film layer 30 is electrically connecting with the lateral support 20 directly. The longitudinal electrode is formed by the longitudinal transparent conductive thin film layer 32 is electrically connecting with the longitudinal support 22 via the wire or pin through the through hole 6.

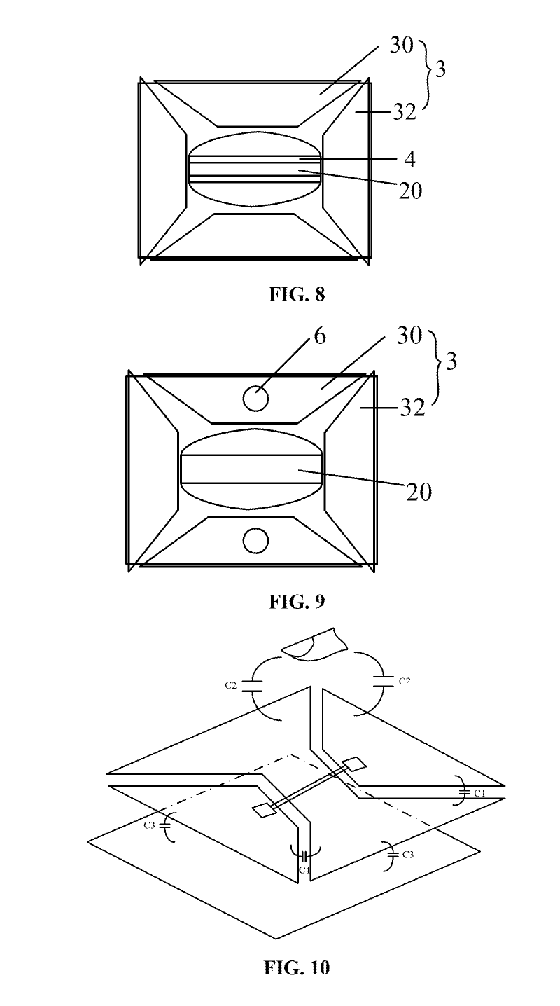

In the present invention, refer to FIGS. 6-7, there are four transparent conductive thin film layers covered on the same plane. The transparent conductive thin film layers comprise two lateral transparent conductive thin film layers 30 and two longitudinal transparent conductive thin film layers 32. A plurality of touch areas are formed by the lateral supports 20 and longitudinal supports 22 vertically intersecting. The transparent conductive thin film layers 3 on the touch areas are insulated to each other. When the finger contacts on the touch areas, the lateral electrode and the longitudinal electrode on the touch areas are electrically connecting, and then the voltage between the lateral electrode and the longitudinal electrode will be change with the changing of the electric capacity. After calculating, the touch position by the finger can be found. The sensitivity of the touch screen will be increasing with a plurality of touch areas.

In the present invention, the conduct is the finger. With the change of the electric capacity by touching, the voltage can be calculated out and then the touch position can be found. The transparent conductive thin film layers are made of tin indium oxide (ITO) and the insulating layer is made of silicon nitride or silicon dioxide.

FIG. 10 showing a distribution view of the electric capacity of the touch screen with mutual capacitance. If the conductor not contacts on the touch substrate, the voltage between the mutual capacitance is V2=V1×C1/(C1+C3); if the conductor contacts on the touch substrate, the voltage between the mutual capacitance is V2′=V1*C1/(C1+C2+C3); the anti noise ratio (SNR) is V2-V2′. Therein, V1 is input voltage of the touch screen, C1 is mutual capacitance between the lateral electrode and the longitudinal electrode, C2 is conductor capacitance between the conductor and the lateral electrode or the longitudinal electrode, C3 is parasitic capacitance between the lateral electrode or the longitudinal electrode and the touch substrate.

The touch substrate is mounted under the transparent conductive thin film layer 3. With the difference between V2 and V2′ enlarging, the touch position will easier be apperceived. Therefore, with the conductor capacitance C2 enlarging, the anti noise ratio (SNR) is better. In the metal support layer 2, the transmitting terminal and the receiving terminal of the electrode is used metal instead of transparent conductive thin film layer. The resistance value of the metal support layer is small, so thus the RC loading is smaller. To solve the disadvantages of the metal with light-proof and reflecting the external light, the transparent conductive thin film layer 3 can be electroplated on the metal support layer 2 to enlarge the touch area by the conduct and ensure the transmittance of the touch screen. The RC loading will be reducing with the signal transmitting by the metal support layer 2, so that the lateral transparent conductive thin film layer and the longitudinal transparent conductive thin film layer can be made even larger to suitable for the large-size touch screen with mutual capacitance.

The following is the change value of C1 and C2 on the prior touch screen and the present touch screen:

The prior touch screen: C1 is 1.77^{e-12}; C2 is 1.3^{e-14};

The present touch screen: C1 is 1.97^{e-12}; C2 is 1.5^{e-12}.

With the conductor capacitance C2 between the conductor and the transparent conductive thin film layer increasing, the touch sensitivity will be also strengthened.

On the one hand, the lateral support and the longitudinal support are insulated by the insulating layer at the junction or entirely covered between them. At the other hand, the metal support layer 2 and the transparent conductive thin film layer 3 are electrically connecting via wire or pin through the through hole to form the electric capacity, they are also insulated at the junction or entirely insulated. When the conductor contacts on the touch substrate, the conductor capacity C2 will be changed. With the conductor capacity C2 increasing, then the touch sensitivity will be strengthened. In the metal support layer 2, the transmitting terminal and the receiving terminal of the electrode is used metal instead of transparent conductive thin film layer, so the light transmittance of the touch screen with mutual capacitance will be increasing to more adapt to the large-size touch screen.

What is claimed is:

1. A touch screen with mutual capacitance, comprising:
a touch substrate;
a metal support layer mounted under the touch substrate, the metal support layer comprising a lateral support and a longitudinal support which the two supports are perpendicular to each other and not on the same plane;
an insulating layer sandwiched between the lateral support and the longitudinal support; and
at least two transparent conductive thin film layers comprising a lateral transparent conductive thin film layer and a longitudinal transparent conductive thin film layer, a lateral electrode made by the electrically connecting the lateral support with the lateral transparent conductive thin film layer, a longitudinal electrode made by the electrically connecting the longitudinal support with the longitudinal transparent conductive thin film layer, the lateral transparent conductive thin film layer being covered along the lateral support, and the width of the lateral transparent conductive thin film layer being larger than the lateral support in the vertical direction, the longitudinal transparent conductive thin film layer being covered along the longitudinal support, and the width of the longitudinal transparent conductive thin film layer being also larger than the longitudinal support.

2. The touch screen with mutual capacitance according to claim 1, wherein the insulating layer is entire covered on the lateral support and the touch substrate.

3. The touch screen with mutual capacitance according to claim 1, wherein the insulating layer is sandwiched on the staggered positions which is between the lateral support and the longitudinal support.

4. The touch screen with mutual capacitance according to claim 2, wherein a through hole is opening on the insulating layer of the lateral support, and the lateral transparent conductive thin film layer is connecting with the lateral support by the wire through the through hole.

5. The touch screen with mutual capacitance according to claim 3, wherein the longitudinal transparent conductive thin film layer is directly connecting with the longitudinal support.

6. The touch screen with mutual capacitance according to claim 1, wherein there are four transparent conductive thin film layers around the staggered positions of the lateral support and the longitudinal support, the transparent conductive thin film layers comprises two lateral transparent conductive thin film layers and two longitudinal transparent conductive thin film layers.

7. The touch screen with mutual capacitance according to claim 6, wherein the four transparent conductive thin film layers are covered on the same plane.

8. The touch screen with mutual capacitance according to claim 7, wherein a plurality of touch areas are formed by the lateral supports and longitudinal supports vertically intersecting, the transparent conductive thin film layers on the touch areas are insulated to each other.

9. The touch screen with mutual capacitance according to claim 8, wherein
if the conductor not contacts on the touch substrate, the voltage between the mutual capacitance is V2=V1×C1/(C1+C3);
if the conductor contacts on the touch substrate, the voltage between the mutual capacitance is V2′=V1*C1/(C1+C2+C3);
the anti noise ratio is V2-V2′;
wherein V1 is input voltage of the touch screen, C1 is mutual capacitance between the lateral electrode and the longitudinal electrode, C2 is conductor capacitance between the conductor and the lateral electrode or the longitudinal electrode, C3 is parasitic capacitance between the lateral electrode or the longitudinal electrode and the touch substrate.

10. A touch screen with mutual capacitance, comprising:
a touch substrate;
a metal support layer mounted under the touch substrate, the metal support layer comprising a lateral support and a longitudinal support which the two supports are perpendicular to each other and not on the same plane;
an insulating layer sandwiched between the lateral support and the longitudinal support;
at least two transparent conductive thin film layers comprising a lateral transparent conductive thin film layer and a longitudinal transparent conductive thin film layer, a lateral electrode made by the electrically connecting the lateral support with the lateral transparent conductive thin film layer, a longitudinal electrode made by the electrically connecting the longitudinal support with the longitudinal transparent conductive thin film layer, the lateral transparent conductive thin film layer being covered along the lateral support, and the width of the lateral transparent conductive thin film layer being larger than the lateral support in the vertical direction.

11. The touch screen with mutual capacitance according to claim 10, wherein the longitudinal transparent conductive thin film layer is covered along the longitudinal support, and the width of the longitudinal transparent conductive thin film layer is also larger than the longitudinal support.

12. The touch screen with mutual capacitance according to claim 11, wherein the insulating layer is entire covered on the lateral support and the touch substrate.

13. The touch screen with mutual capacitance according to claim 11, wherein the insulating layer is sandwiched on the staggered positions which is between the lateral support and the longitudinal support.

14. The touch screen with mutual capacitance according to claim 12, wherein a through hole is opening on the insulating layer of the lateral support, and the lateral transparent conductive thin film layer is connecting with the lateral support by the wire through the through hole.

15. The touch screen with mutual capacitance according to claim 13, wherein the longitudinal transparent conductive thin film layer is directly connecting with the longitudinal support.

16. The touch screen with mutual capacitance according to claim 10, wherein there are four transparent conductive thin film layers around the staggered positions of the lateral support and the longitudinal support, the transparent conductive thin film layers comprises two lateral transparent conductive thin film layers and two longitudinal transparent conductive thin film layers.

17. The touch screen with mutual capacitance according to claim 16, wherein the four transparent conductive thin film layers are covered on the same plane.

18. The touch screen with mutual capacitance according to claim 17, wherein a plurality of touch areas are formed by the lateral supports and longitudinal supports vertically intersecting, the transparent conductive thin film layers on the touch areas are insulated to each other.

19. The touch screen with mutual capacitance according to claim 18, wherein
if the conductor not contacts on the touch substrate, the voltage between the mutual capacitance is V2=V1×C1/(C1+C3);
if the conductor contacts on the touch substrate, the voltage between the mutual capacitance is V2′=V1*C1/(C1+C2+C3);
the anti noise ratio is V2-V2′;
wherein V1 is input voltage of the touch screen, C1 is mutual capacitance between the lateral electrode and the longitudinal electrode, C2 is conductor capacitance between the conductor and the lateral electrode or the longitudinal electrode, C3 is parasitic capacitance between the lateral electrode or the longitudinal electrode and the touch substrate.

20. The touch screen with mutual capacitance according to claim 19, wherein the transparent conductive thin film layers are made of tin indium oxide and the insulating layer is made of silicon nitride or silicon dioxide.
